(19) United States
(12) Patent Application Publication
(10) Pub. No.: US 2014/0240720 A1
(43) Pub. Date: Aug. 28, 2014

(54) LINEWIDTH MEASUREMENT SYSTEM

(71) Applicant: 3M INNOVATIVE PROPERTIES COMPANY, St. Paul, MN (US)

(72) Inventors: Yi Qiao, Woodbury, MN (US); Michael W. Dolezal, Stillwater, MN (US); David L. Hofeldt, Oakdale, MN (US); Jack W. Lai, Lake Elmo, MN (US); Catherine P. Tarnowski, Mahtomedi, MN (US)

(21) Appl. No.: 14/347,022

(22) PCT Filed: Sep. 13, 2012
(86) PCT No.: PCT/US2012/055003

§ 371 Date: Mar. 25, 2014

Related U.S. Application Data
(60) Provisional application No. 61/542,061, filed on Sep. 30, 2011.

(51) Int. Cl. G01B 11/04

(52) U.S. Cl. CPC G01B 11/04
USPC 356/625

(57) ABSTRACT

A method includes passing an interrogating light beam through a Fourier transform lens and onto the surface of a material to form a Fraunhofer diffraction pattern of one or more surface features of the material. An image of the diffraction pattern is processed to determine the dimensions of the feature.

### CROSS REFERENCE TO RELATED APPLICATION

This application claims the benefit of U.S. Provisional Application No. 61/542,061, filed Sep. 30, 2011, the disclosure of which is incorporated by reference in its entirety herein.

### TECHNICAL FIELD

The present disclosure relates to material inspection systems, such as computerized systems for the inspection of moving webs of material.

### BACKGROUND

Many different industries utilize processes for making micro-scale patterns on a surface of a substrate. These micro-scale patterns include an array of surface features, such as elongate grooves extending below the surface or raised ribs extending above the surface. During manufacture of a substrate including such an array of surface features, microscope imaging has been used to measure the dimensions of one or more features in the array. However, microscope imaging has a small depth of field and a narrow field of view, which has restricted its use to off-line analysis of the surface features on the substrate.

### SUMMARY

An inspection technique is needed to provide real-time measurement of the dimensions of the surface features on a surface of a material as the material is being manufactured. In general, the present disclosure is directed to an apparatus and a method for measuring the dimensions of a selected surface feature in a material by processing an image of a Fraunhofer diffraction pattern of the surface feature. This measurement technique can be used to monitor the dimensions of the selected feature off-line or on-line as the material is being manufactured.

In one embodiment, the present disclosure is directed to a method including passing an interrogating light beam through a Fourier transform lens and onto the surface of a material to form a Fraunhofer diffraction pattern of one or more surface features of the material; forming an image of the diffraction pattern; and processing the image of the diffraction pattern to determine the dimensions of the feature.

In another embodiment, the present disclosure is directed to an apparatus including a light source that emits an interrogating beam into a Fourier transform lens and onto a surface to form a Fraunhofer diffraction pattern of one or more features on the surface, wherein the lens and the surface are arranged in a reverse Fourier transform mode; an image acquisition device that captures an image of the Fraunhofer diffraction pattern of the feature on the surface; and a processor to determine the diffraction pattern size and calculate a dimension of the feature on the surface.

In yet another embodiment, the present disclosure is directed to a system for monitoring the dimensions of one or more selected features on a surface of a material, including a light source positioned proximal to the surface, wherein the light source emits an interrogating beam through a Fourier transform lens and onto the surface, wherein the surface is between the Fourier transform lens and the focus thereof; a camera to capture the image of a Fraunhofer diffraction pattern of the feature on the surface; and a processor to measure the size of the Fraunhofer diffraction pattern to determine the dimensions of the feature.

In yet another embodiment, the present disclosure is directed to a method, including positioning a light source proximal to a surface of a non-stationary web of a flexible material, wherein the web includes an arrangement of features in a surface thereof, and wherein the light source emits an interrogating beam through a Fourier transform lens and onto the surface of the web, and wherein the surface of the web and the Fourier transform lens are positioned in a reverse Fourier Transform mode; scanning the interrogating beam over the surface of the web to form a Fraunhofer diffraction pattern of one of more of the features; projecting an image of the diffraction pattern onto a screen or a lens; capturing with a camera the image of the diffraction pattern on the screen or lens; and measuring the diffraction pattern size to determine the dimensions of a selected feature.

In another embodiment, the present disclosure is directed to a method for inspecting web material in real time and computing a dimension of one or more features on a surface of the web material as the web material is manufactured, including positioning a light source proximal to the surface of a the web material, wherein the light source emits an interrogating beam through a Fourier transform lens and onto the surface of the web material, and wherein the surface of the web and the Fourier transform lens are arranged in a reverse Fourier Transform mode; scanning the interrogating beam over the surface of the web material to form a Fraunhofer diffraction pattern of the features on the surface; projecting an image the diffraction pattern onto a screen or lens; imaging the screen or lens with a camera, wherein the camera measures the diffraction pattern size; and computing the dimensions of the selected feature based on the diffraction pattern size.

In yet another embodiment, the present disclosure is directed to an online computerized inspection system for inspecting web material in real time, the system including a light source positioned proximal to the surface of a the web material, wherein the light source emits an interrogating beam through a Fourier transform lens and onto the surface of the web material, and wherein the surface of the web and the Fourier transform lens are positioned in a reverse Fourier Transform mode; a scanner to scan the light interrogating beam over the surface of the web material to form a Fraunhofer diffraction pattern of one or more features in the web material; a screen or lens having thereon an image of the diffraction pattern; a camera to capture the image of the diffraction pattern on the screen or lens, wherein the camera measures a diffraction pattern size; and a computer executing software to determine the dimensions of a selected feature based on the measured diffraction pattern size.

In yet another embodiment, the present disclosure is directed to a non-transitory computer readable medium comprising software instructions to cause a computer processor to: receive, with an online computerized inspection system, an image of a Fraunhofer diffraction pattern of one or more features on a surface of a web material during the manufacture thereof, wherein the inspection system measures a diffraction pattern size; determine the dimensions of a selected feature based on the measured diffraction pattern size; and compute the severity of a non-uniformity defect in the web material based on the calculated dimensions of the selected feature.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a schematic plan view of an embodiment of an apparatus for measuring the dimensions of a surface feature of a material by imaging a reflected Fraunhofer diffraction pattern of the surface feature.

FIG. 2 is an example of an interference pattern characteristic of an array of surface features as modulated by a sine-squared envelope function.

FIG. 3 is a schematic plan view of an embodiment of an apparatus for measuring the dimensions of a surface feature of a material by imaging a transmitted Fraunhofer diffraction pattern of the surface feature.

FIG. 4 is a flowchart illustrating an embodiment of a method for measuring the dimensions of a surface feature.

FIG. 5 is a flowchart illustrating another embodiment of a method for measuring the dimensions of a surface feature.

FIG. 6 schematic block diagram of an exemplary embodiment of an inspection system in an exemplary web manufacturing plant.

FIGS. 7A-7C are microscope images of micro-fabricated structures having a line width of 3 μm, 4 μm and 5 μm, respectively.

FIGS. 8A-8C are the corresponding Fraunhofer diffraction patterns from the structures of FIGS. 7A-7C, as measured using the apparatus described in Example 1.

FIG. 9 is plot of diffraction pattern size vs. line width for the structures analyzed in Example 1.

Like symbols in the drawings indicate like elements.

### DETAILED DESCRIPTION

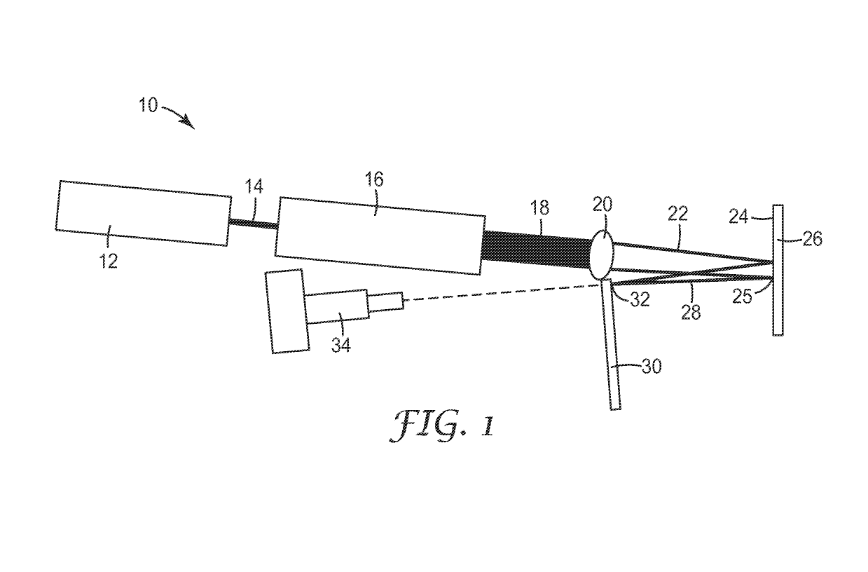

FIG. 1 is schematic illustration of an embodiment of an apparatus that may be used to measure the dimensions of a surface feature of a material. The apparatus 10 includes a light source 12, which emits a light beam 14 into an optional beam expander 16. The expanded light beam 18 passes through a Fourier Transform lens 20, and the focused light rays 22 are incident onto a sample surface 24 of a material 26. The sample surface 24 includes an array of surface features 25 such as, for example, grooves, channels, depressions, pits, apertures, mounds, ribs, shelves, and the like. The surface features 25 have microscopic dimensions, which are sufficiently small to be indistinguishable by the naked eye without the use of an optical microscope. Such microscopic features typically have dimensions of less than about 0.01 mm, or less than about 0.0001 mm.

The sample surface 24 is placed between the Fourier Transform lens 20 and the focus thereof. This arrangement of components is a converging beam optical Fourier Transform, where the converging beam is reflected off an object before coming to a focus. See, for example, Goodman, Introduction to Fourier Optics, McGraw-Hill, 1968; and Puang-ngern and Almeida, Converging beam optical Fourier transforms, Am. J. Phys. 53 (8), August 1985, pp. 762-765. Such component configurations are also referred to as a reverse Fourier Transform mode arrangement. See, for example, http://www.fritsch.cn/Download/200622495654214.pdf; and Xu, Particle Characterization: Light Scattering Methods, Springer, 2001.

An image acquisition device 34 captures the light 28 reflected from the surface features 25, which is a Fraunhofer diffraction pattern 32 characteristic of the features 25. If the diffraction pattern 32 is too large for the sensor within the image acquisition device 34, the diffraction pattern 32 may be projected on an optional screen 30, and/or may be further focused by an optional lens system (not shown in FIG. 1). A processor within the image acquisition device 34 may be used to analyze the Fraunhofer diffraction pattern 32 and determine the dimensions of selected surface features 25.

Suitable light sources 12 may vary widely depending on the type of surface to be analyzed. Collimated light sources such as lasers are particularly preferred, and suitable lasers include He-Ne lasers, diode lasers and the like.

Any convex lens may be used as the Fourier Transform lens 20, but convex lenses such as plano-convex lens with the lens plano side facing the focus, have been found to be suitable.

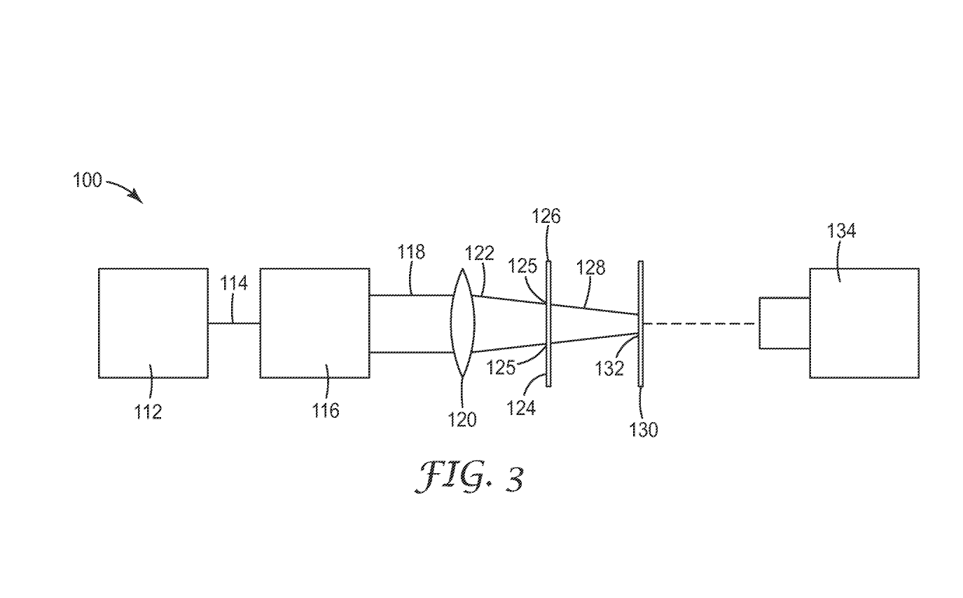

The sample surface 24 including the features 25 may be made from any material 26, and the surface 24 may be stationary or non-stationary (moving). The material 26 may reflect the light beam emitted by the light source 12 as shown in FIG. 1, or may transmit the beam (FIG. 3).

For example, the analysis method and apparatus described herein are particularly well suited, but are not limited to, inspecting the surface features 25 of web-like rolls of materials 26. In general, the web rolls 26 may contain manufactured web material that may be any sheet-like material having a fixed dimension in one direction and either a predetermined or indeterminate length in the orthogonal direction. Examples of web materials include, but are not limited to, metals, paper, wovens, non-wovens, glass, polymeric films, flexible circuits or combinations thereof. Metals may include such materials as steel or aluminum. Wovens generally include various fabrics. Non-wovens include materials, such as paper, filter media, or insulating material. Films include, for example, clear and opaque polymeric films including laminates and coated films.

The image acquisition device 34 may also vary widely depending on the intended application, but cameras, particularly CCD cameras have been found to be particularly well suited for use in the apparatus.

As noted above, the image acquisition device 34 includes an imaging system that is used to analyze the image of the Fraunhofer diffraction pattern 32. The imaging system includes a processor that may be used to analyze characteristics of the Fraunhofer diffraction pattern 32 and, based on these characteristics, calculates selected dimensions of selected surface features 25.

For example, if the surface feature 25 is a groove or a channel in the surface 24 of the material 26, the width of the groove may be determined from diffraction theory. For a single line with a line width d, its characteristic Fraunhofer diffraction pattern 32 is a sine-squared function and the distance from the first diffraction minimum to the central zero order beam is:

s=(F×λ)/d eq. 1

in which s is the distance from the first diffraction minimum to the zero order beam (subsequently referred as diffraction pattern size for simplicity), F is the focal length of the Fourier transform lens 20, and λ is the wavelength of the light source 12.

For a camera imaging system with magnification M, eq. 1 changes to:

s=(M×F×λ)/d eq. 2

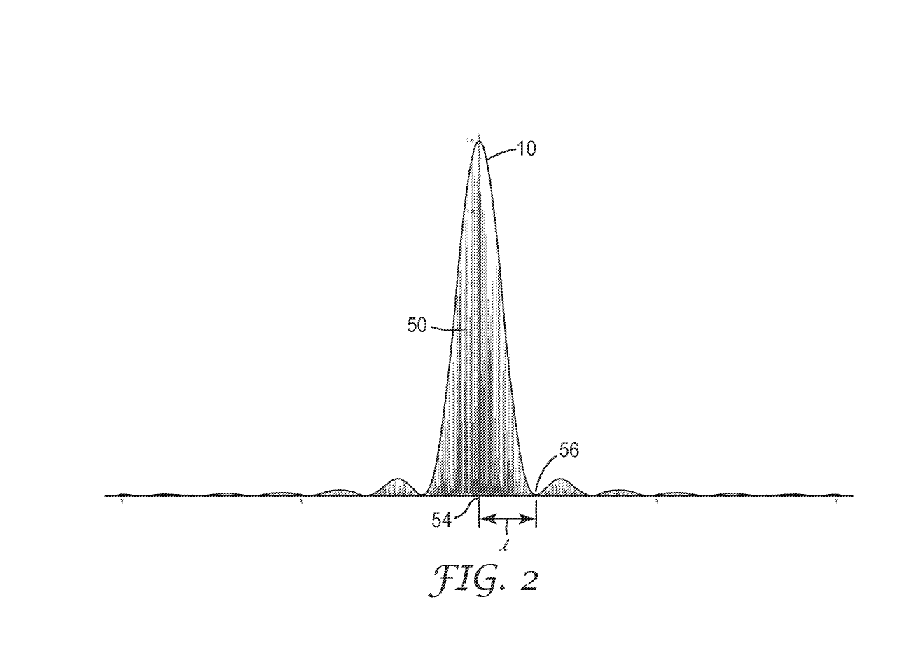

If an array or pattern of features 25 on a surface contains periodic line structure, as shown in FIG. 2, its diffraction pattern 50 can be thought of as an interference pattern modulated by the sine-squared diffraction envelope function 52. As shown is equation 2 above, the line width d of a selected feature 25 in the array or pattern is related to the diffraction pattern size—the distance/between the central zero order beam 54 and the diffraction first minimum 56.

The analysis of the Fraunhofer diffraction pattern performed by the imaging system is not limited to the procedure above, and many suitable techniques may be used. For example, the imaging system may determine the distance between any two minima in the diffraction pattern, or may fit measured positions of minima to a model for the diffraction pattern.

FIG. 3 is another embodiment of an apparatus 100 that may be used to determine the dimensions of selected features on a surface of a material. A light source 112 emits a light beam 114 into an optional beam expander 116. The expanded light beam 118 passes through a Fourier Transform lens 120, and the focused light rays 122 are incident onto a sample surface 124 of a material 126. The sample surface 124 includes an array of surface features 125 with microscopic dimensions. The sample surface 124 is placed between the Fourier Transform lens 120 and the focus thereof, which is referred to as a reverse Fourier Transform mode arrangement. The light 128 transmitted through the material 126 is focused on an optional screen 130, and on the screen 130 appears a Fraunhofer diffraction pattern 132 characteristic of the features 125. An image acquisition device 134 captures the image of the Fraunhofer diffraction pattern, and an imaging system within the device 134 may be used to analyze the Fraunhofer diffraction pattern 132. Based on the characteristics of the diffraction pattern 132, a processor in the device 134 may be used to determine the dimensions of selected surface features 125.

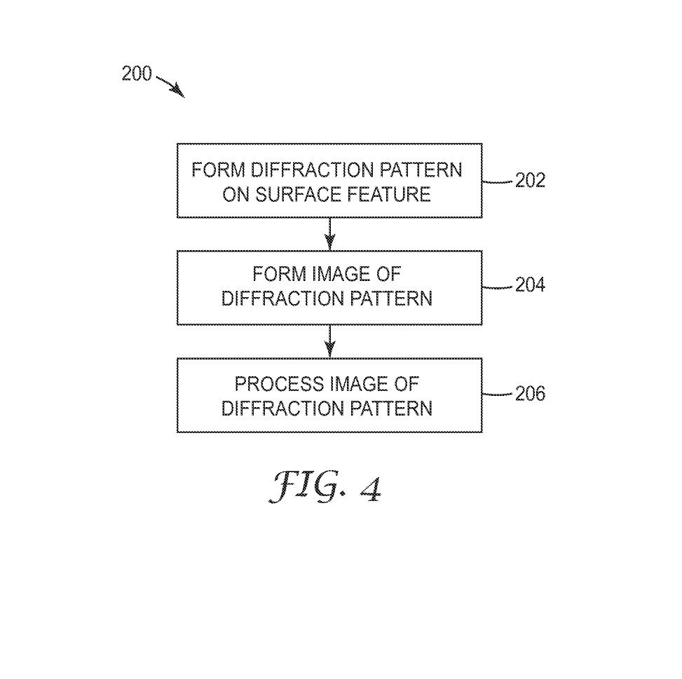

FIG. 4 is a flowchart illustrating a method 200 of operating the apparatus in FIG. 1 or FIG. 3 to determine the dimensions of a selected feature on a surface of a substrate. Referring to FIG. 4, in step 202 the apparatus forms a Fraunhofer diffraction pattern of a surface feature of a material, and in step 204 an image of the diffraction pattern is projected on a sensor of an image acquisition device. In step 206 the image of the diffraction pattern is processed by the image acquisition device to determine the dimensions of the feature.

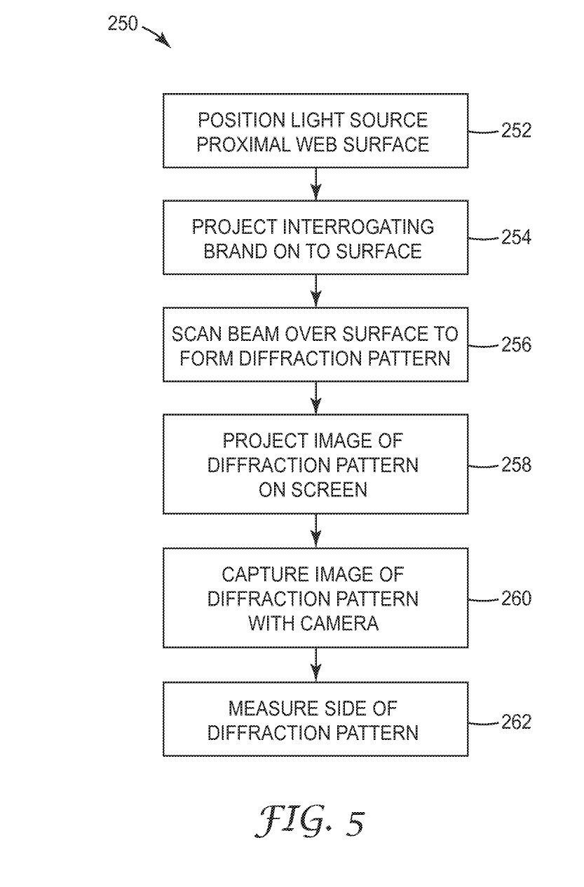

FIG. 5 is a flow chart illustrating an embodiment of a method 250 of operating the apparatus in FIG. 1 or FIG. 3 to determine the dimensions of a selected feature (for example, a groove or a projection) on a surface of a non-stationary web of a flexible material. In step 252 a light source is positioned proximal to a surface of the non-stationary web. In step 254 the light source emits an interrogating beam through a Fourier transform lens and onto the surface of the web, wherein the surface of the web and the Fourier transform lens are positioned in a reverse Fourier Transform mode. In step 256 the interrogating beam is moved over the surface of the web to form a Fraunhofer diffraction pattern of one or more features on the surface of the web, and in step 258 the image of the diffraction pattern is projected onto an optional screen, which is utilized to more conveniently image a large diffraction pattern. In step 260 the image of the diffraction pattern on the screen is captured with an image acquisition device such as a CCD camera. In step 262 the image acquisition device then measures the diffraction pattern size to determine a dimension (for example, the width or height) of a selected feature on the web surface.

In some embodiments, the apparatus of FIG. 1 or FIG. 3 may be utilized in one or more inspection systems to inspect web materials during manufacture. To produce a finished web roll that is ready for conversion into individual sheets for incorporation into a product, unfinished web rolls may undergo processing on multiple process lines either within one web manufacturing plant, or within multiple manufacturing plants. For each process, a web roll is used as a source roll from which the web is fed into the manufacturing process. After each process, the web is typically collected again into a web roll and moved to a different product line or shipped to a different manufacturing plant, where it is then unrolled, processed, and again collected into a roll. This process is repeated until ultimately a finished web roll is produced. For many applications, the web materials for each of the web rolls may have numerous coatings applied at one or more production lines of the one or more web manufacturing plants. The coating is generally applied to an exposed surface of either a base web material, in the case of a first manufacturing process, or a previously applied coating in the case of a subsequent manufacturing process. Examples of coatings include adhesives, hardcoats, low adhesion backside coatings, metalized coatings, neutral density coatings, electrically conductive or nonconductive coatings, or combinations thereof.

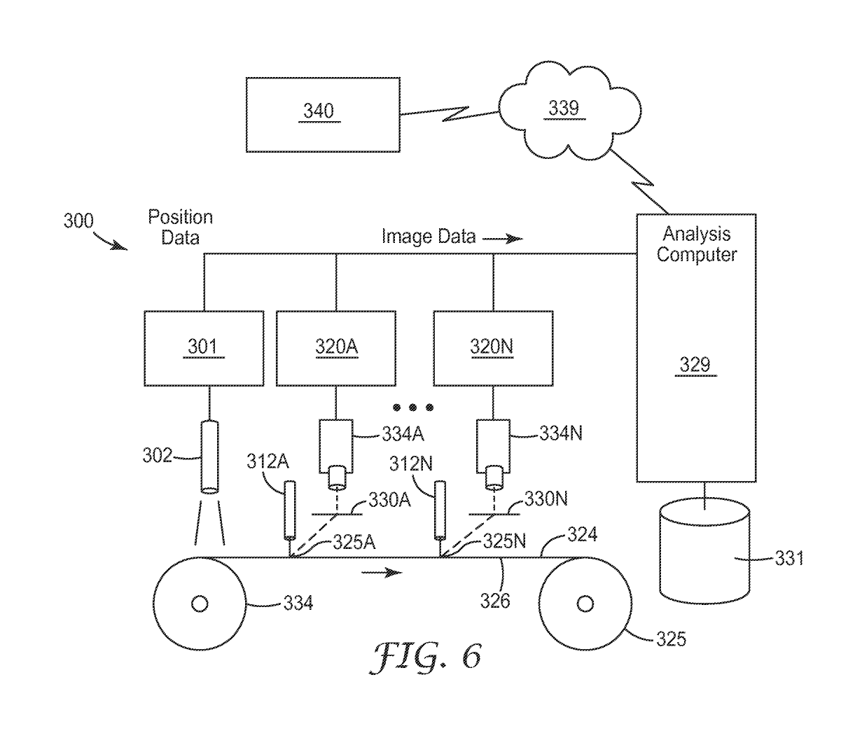

In the exemplary embodiment of an inspection system 300 shown in FIG. 6, a segment of a web 326 is positioned between two support rolls 323, 325. The inspection system 300 includes a fiducial mark controller 301, which controls fiducial mark reader 302 to collect roll and position information from the 326. In addition, fiducial mark controller 30 may receive position signals from one or more high-precision encoders engaged with web 326 and/or support rollers 323, 325. Based on the position signals, the fiducial mark controller 301 determines position information for each detected fiducial mark. The fiducial mark controller 301 communicates the roll and position information to an analysis computer 329 for association with detected data regarding the dimensions of features on a surface of the web 324.

The system 300 further includes one or more optical systems 312A-312N, which each include a laser and a Fourier Transform lens arranged in reverse Fourier Transform mode. The optical systems 312 are positioned in close proximity to a surface 324 of the continuously moving web of material 326 as the web is processed, and scan sequential portions of the continuously moving web 326 to obtain digital image data.

The optical systems 312 project an interrogating beam onto the web surface 324, and in a preferred embodiment the resulting Fraunhofer diffraction pattern characteristics of surface features 325A-N of the web 326 are projected on screens 330A-N (as noted above, the screens are not required, but simplify imaging of large diffraction patterns). A series of image acquisition cameras 334A-N capture the diffraction patterns on the screens 330A-N. An image data acquisition computer 327 collects image data from the cameras 334 and transmits the image data to an analysis computer 329. The analysis computer 329 processes streams of image data from the image acquisition computers and analyzes the digital images with one or more algorithms to measure the diffraction pattern size and calculate the dimensions of the surface features 325. The analysis computer 329 may display the results on an appropriate user interface and/or may store the results in a database 331.

The inspection system 300 shown in FIG. 6 may be used within a web manufacturing plant to apply algorithms for detecting the presence of non-uniformity defects in the web surface 324. The inspection system 300 may also provide output data that indicates a severity of each defect in real-time as the web is manufactured. For example, the computerized inspection systems may provide real-time feedback to users, such as process engineers, within web manufacturing plants regarding the presence of non-uniformities and their severity, thereby allowing the users to quickly respond to an emerging non-uniformity by adjusting process conditions to remedy a problem without significantly delaying production or producing large amounts of unusable material. The computerized inspection system 300 may apply algorithms to compute the severity level by ultimately assigning a rating label for the non-uniformity (e.g., “good” or “bad”) or by producing a measurement of non-uniformity severity of a given sample on a continuous scale or more accurately sampled scale.

The analysis computer 329 may store the feature dimension information for the web 326, including roll identifying information for the web 326 and possibly position information for each measured feature, within the database 331. For example, the analysis computer 329 may utilize position data produced by fiducial mark controller 301 to determine the spatial position or image region of each measured feature within the coordinate system of the process line. That is, based on the position data from the fiducial mark controller 301, the analysis computer 329 determines the x, y, and possibly z position or range for each measured feature within the coordinate system used by the current process line. For example, a coordinate system may be defined such that the x dimension represents a distance across web 326, a y dimension represents a distance along a length of the web, and the z dimension represents a height of the web, which may be based on the number of coatings, materials or other layers previously applied to the web. Moreover, an origin for the x, y, z coordinate system may be defined at a physical location within the process line, and is typically associated with an initial feed placement of the web 326.

The database 331 may be implemented in any of a number of different forms including a data storage file or one or more database management systems (DBMS) executing on one or more database servers. The database management systems may be, for example, a relational (RDBMS), hierarchical (HDBMS), multidimensional (MDBMS), object oriented (ODBMS or OODBMS) or object relational (ORDBMS) database management system. As one example, the database 32 is implemented as a relational database available under the trade designation SQL Server from Microsoft Corporation, Redmond, WA.

Once the process has ended, the analysis computer 329 may transmit the data collected in the database 331 to a conversion control system 340 via a network 339. For example, the analysis computer 329 may communicate the roll information as well as the feature dimension and/or anomaly information and respective sub-images for each feature to the conversion control system 340 for subsequent, offline, detailed analysis. For example, the feature dimension information may be communicated by way of database synchronization between the database 331 and the conversion control system 340.

In some embodiments, the conversion control system 340 may determine those products of products for which each anomaly may cause a defect, rather than the analysis computer 329. Once data for the finished web roll has been collected in the database 331, the data may be communicated to converting sites and/or used to mark anomalies on the web roll, either directly on the surface of the web with a removable or washable mark, or on a cover sheet that may be applied to the web before or during marking of anomalies on the web.

The components of the analysis computer 329 may be implemented, at least in part, as software instructions executed by one or more processors of the analysis computer 329, including one or more hardware microprocessors, digital signal processors (DSPs), application specific integrated circuits (ASICs), field programmable gate arrays (FPGAs), or any other equivalent integrated or discrete logic circuitry, as well as any combinations of such components. The software instructions may be stored within in a non-transitory computer readable medium, such as random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media.

Although shown for purposes of example as positioned within a manufacturing plant, the analysis computer 329 may be located external to the manufacturing plant, e.g., at a central location or at a converting site. For example, the analysis computer 329 may operate within the conversion control system 340. In another example, the described components execute on a single computing platform and may be integrated into the same software system.

The subject matter of the present disclosure will now be described with reference to the following non-limiting examples.

### EXAMPLES

### Example 1

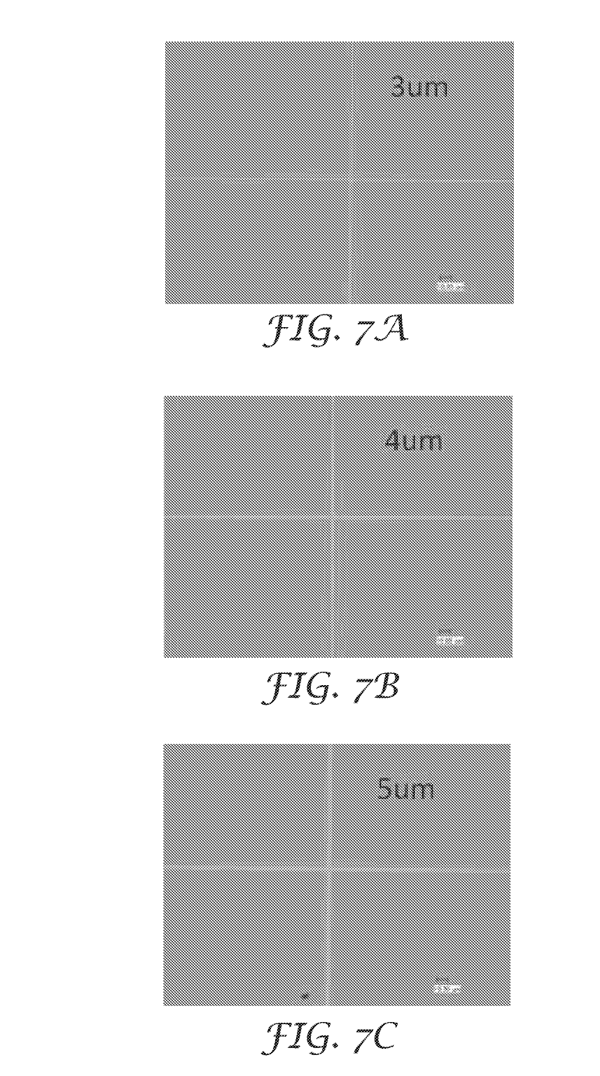

FIGS. 7A-7C are microscope images of microfabricated structures having a line width of 3 μm (FIG. 7A), 4 μm (FIG. 7B) and 5 μm (FIG. 7C).

Using the apparatus shown in FIG. 1 with a He-Ne laser and a Fourier Transform lens having a focal length of 200 mm, an interrogating beam was applied to the structures in

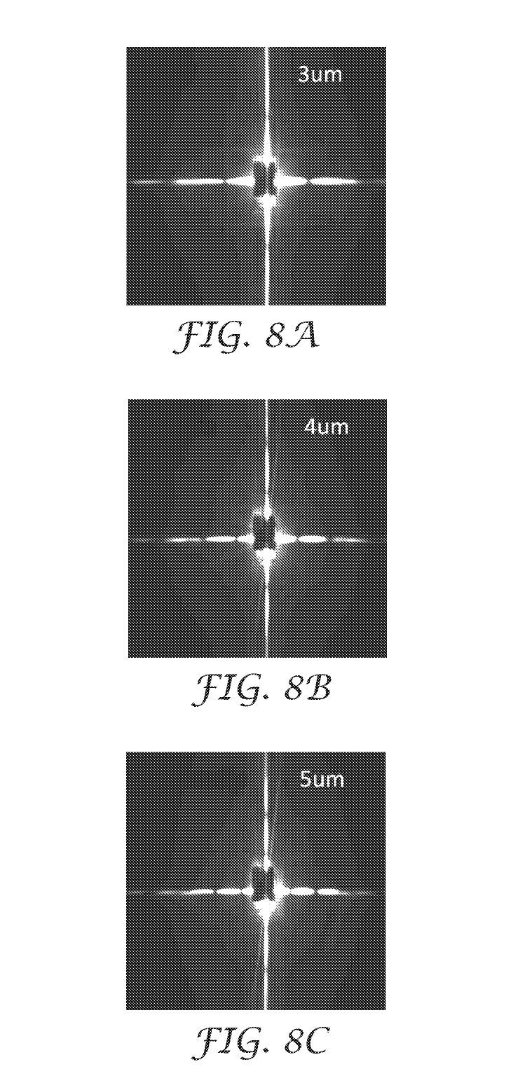

FIGS. 7A-7C. The corresponding Fraunhofer diffraction pattern measured for each structure is shown in FIGS. 8A-8C. As the line width increased, the diffraction pattern size decreased.

The measured diffraction pattern sizes (the distance/between the central zero order beam 54 and the diffraction first minimum 56 as shown in FIG. 2 above) in pixels for the micro-fabricated structures of FIGS. 7A-7C with increments of 0.2 μm are shown in Table 1:

TABLE 1

| | Linewidth (μm) | | | | | | | | | | |
|---|---|---|---|---|---|---|---|---|---|---|---|
| | 3 | 3.2 | 3.4 | 3.6 | 3.8 | 4 | 4.2 | 4.4 | 4.6 | 4.8 | 5 |
| Diffraction | 1275 | 1180 | 1136 | 1048 | 984 | 931 | 898 | 857 | 806 | 781 | 744 |
| Pattern | | | | | | | | | | | |
| Size | | | | | | | | | | | |
| (pixels) | | | | | | | | | | | |

As noted above, a Fourier Transform lens with 200 mm focal length was used to obtain the data listed in Table 1. In principle, the longer this focal length, the higher the sensitivity to the linewidth changes. In practice, this focal length will be limited by screen size and camera sensor size.

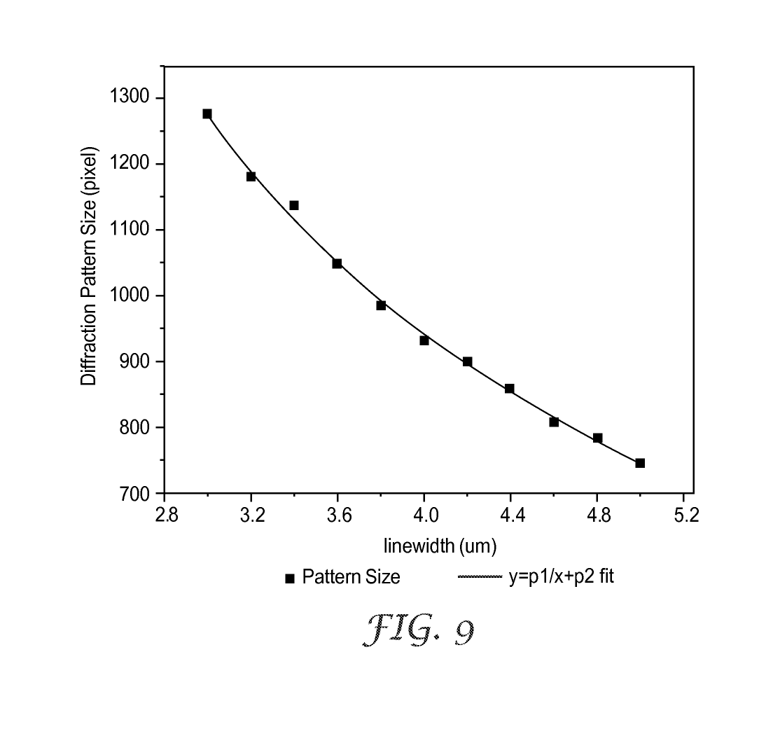

FIG. 9 shows the graph of the measured diffraction pattern sizes of Table 1 plotted versus structure line widths. The curve in FIG. 9 is the fit of the data in the form of

$$y = \frac{p 1}{x} + p 2.$$

FIG.b 9 makes clear that the diffraction pattern size is inversely related to the line width as eq. 2 above predicted.

Various embodiments of the invention have been described. These and other embodiments are within the scope of the following claims.

1. A method, comprising:
passing an interrogating light beam through a Fourier transform lens and onto the surface of a material to form a Fraunhofer diffraction pattern of one or more surface features of the material;
forming an image of the diffraction pattern; and
processing the image of the diffraction pattern to determine the dimensions of the feature.

2. The method of claim 1, wherein the dimension of the feature is determined from a distance between a central order beam and a first diffraction minimum in the diffraction pattern.

3. (canceled)

4. The method of claim 1, wherein the image of the diffraction pattern is formed by reflecting the interrogating beam off the surface of the material and onto a screen or a lens.

5. The method of claim 1, wherein the image of the diffraction pattern is formed by transmitting the interrogating beam through the surface of the material and onto a screen or a lens.

6-10. (canceled)

11. An apparatus, comprising:
a light source that emits an interrogating beam into a Fourier transform lens and onto a surface to form a Fraunhofer diffraction pattern of a feature on the surface, wherein the lens and the surface are arranged in a reverse Fourier transform mode;
an image acquisition device that captures an image of the Fraunhofer diffraction pattern of the feature on the surface; and
a processor to determine the diffraction pattern size and calculate a dimension of the feature on the surface.

12. The apparatus of claim 11, wherein the image acquisition device comprises a CCD camera.

13. The apparatus of claim 11, wherein the processor is within the image acquisition device.

14. The apparatus of claim 11, wherein the light source is collimated.

15. The apparatus of claim 12, wherein the light source is a laser.

16. The apparatus of claim 11, further comprising a beam expander between the light source and the Fourier transform lens.

17. The apparatus of claim 11, wherein the interrogating beam is reflected off the surface and onto a screen or a lens.

18. The apparatus of claim 11, wherein the interrogating beam is transmitted through the surface and onto a screen or a lens.

19. A system for monitoring a dimension of a selected feature on a surface of a material, comprising:
a light source positioned proximal to the surface, wherein the light source emits an interrogating beam through a Fourier transform lens and onto the surface to form a Fraunhofer diffraction pattern of one or more features on the surface, wherein the surface is between the Fourier transform lens and the focus thereof;
an image acquisition device to capture an image of the Fraunhofer diffraction pattern of the features on the surface; and
a processor to measure the size of the Fraunhofer diffraction pattern to determine a dimension of a selected feature in the array.

20. The system of claim 19, wherein the surface of the material is non-stationary.

21. The system of claim 19, wherein the light source is scanned over the surface of the material.

22. The system of claim 19, wherein the light source is a laser.

23. The system of claim 19, wherein the image of the Fraunhofer diffraction pattern is taken in reflection off the surface of the material.

24. The system of claim 19, wherein the image of the Fraunhofer diffraction pattern is taken via transmission through the surface of the material.

25. The system of claim 19, wherein the light source is above the surface of the material.

26-33. (canceled)

34. An online computerized inspection system for inspecting web material in real time, the system comprising:
a light source positioned proximal to the surface of a the web material, wherein the light source emits an interrogating beam through a Fourier transform lens and onto the surface of the web material, and wherein the surface of the web and the Fourier transform lens are positioned in a reverse Fourier Transform mode;
a scanner to scan the light interrogating beam over the surface of the web material to form a Fraunhofer diffraction pattern of one or more features in the surface web material;
a camera to capture an image of the diffraction pattern, wherein the camera measures a diffraction pattern size; and
a computer executing software to determine the dimensions of a selected surface feature based on the measured diffraction pattern size.

35-37. (canceled)
